(19) United States
(12) Patent Application Publication
(10) Pub. No.: US 2011/0264320 A1
(43) Pub. Date: Oct. 27, 2011

(54) METHOD OF GUIDING A VEHICLE

(75) Inventors: Daniel Arnaud, Saint Etienne (FR); Jean-Pierre Reyal, Eragny (FR)

(73) Assignees: ARCELORMITTAL-STAINLESS & NICKEL ALLOYS, Saint Denis (FR); SOCIETE PLYMOUTH FRANCAISE, Feyzin (FR)

(21) Appl. No.: 13/000,636

(22) PCT Filed: Jun. 18, 2009
(86) PCT No.: PCT/FR2009/051161

§ 371 Date: Feb. 8, 2011

(30) Foreign Application Priority Data
Jun. 23, 2008 (FR) 0803504

(51) Int. Cl. G05D 1/00

(52) U.S. Cl. 701/23

(57) ABSTRACT

The invention relates to a method of guiding a vehicle (1) comprising the following steps: exciting, during the displacement of the vehicle (1), at least one guidance element (4) made of a high-permeability magnetic material affixed to a support, such as a road (3), by way of excitation means (5); detecting the signal emanating from the guidance element (4) following the excitation by way of detection means (6, 7); gathering and processing the signal arising from the detection means (6, 7) so as to guide the vehicle (1). The excitation of the guidance element (4) is carried out in such a way as to saturate or modify the operating point of the guidance element (4) in its operating cycle, which then emits a frequency-rich signal, composed of a wave of fundamental frequency (fₒ) as well as waves of frequencies (nf₀) which are multiplies of the value of the fundamental frequency, and called the harmonics, and in that the excitation is carried out way of a plurality of coils or of a radar generating a rotating excitation magnetic field.

### TECHNICAL FIELD

The invention concerns a method for guiding a vehicle.

### BRIEF DISCUSSION OF RELATED ART

Automatic vehicle guidance concerns different technical fields. It can notably be applied to the guiding of an automobile or a roadwork vehicle such as a snow plough, or to the guiding of industrial trucks.

With respect to snow ploughs in particular, the possibility of precise guiding is of advantage since the usual reference landmarks such as solid or broken traffic lines generally painted on roads are no longer visible when covered by snow. Said guiding method can find particular application in the guiding of snow ploughs on airport runways.

Said vehicle guidance, depending on the field of application, can provide assistance to or even replace an operator or driver.

One known method of vehicle guidance is described in each of documents U.S. Pat. No. 4,800,978 and DE 37 26 212. Said method comprises:
when the vehicle is travelling, exciting at least one guidance element in magnetic material affixed to a support such as a road, via excitation means,
detecting the signal emanating from the guidance element subsequent to excitation via the excitation means,
collecting and processing the signal emanating from the detection means, to guide the vehicle.

The installation of this type of system does not completely eliminate parasitic conducting elements present in the ground or located in the vicinity of the guidance element.

When an electromagnetic wave is transmitted by the excitation means, the conducting elements located in the vicinity of the guidance element also send back a fundamental frequency wave, interacting with the wave emanating from the guidance element.

In is then difficult to separate the signals emitted by the guidance element from those emitted by the parasitic elements, which affects the quality of detection, and hence the precision or reliability of guiding.

### BRIEF SUMMARY

The invention sets out to remedy these shortcomings by proposing a method allowing precise, reliable guiding of a vehicle.

For this purpose, the invention concerns a method for guiding a vehicle comprising the following steps:
when the vehicle is travelling, exciting at least one guidance element in high-permeability magnetic material affixed to a support such as road, via excitation means,
detecting the signal emanating from the guidance element subsequent to excitation, via detection means,
collecting and processing the signal emanating from the detection means to guide the vehicle, characterized in that the excitation of the guidance element is performed so as to saturate or modify the operating point of the guidance element in its operating cycle, which then emits a frequency-rich signal composed of a wave of fundamental frequency and waves of frequencies that are multiples of the value of the fundamental frequency, called harmonics, and in that the excitation is performed via a plurality of coils or a radar generating a rotating excitation magnetic field.

The term <<multiples>> is not to be construed in the strictest meaning. Therefore a multiple frequency wave can be a wave, for example, whose frequency is close to twice the fundamental frequency, but not exactly equal to this value.

With said system it is possible to overcome parasitic, generally conducting, elements buried in the ground or present in the vicinity of the guidance element.

The identification of harmonic waves corresponding to a fundamental wave allows identification and separation of the signals emanating from the parasitic conducting elements and those emanating from the guidance element.

According to one characteristic of the invention, the guidance element is excited via at least one transmitter coil.

Other known types of electromagnetic wave generators can be used.

Advantageously the signal emanating from the guidance element is detected via at least one receiver coil tuned to the frequency of one or more of the harmonics emanating from the guidance element.

According to one possibility of the invention, the excited guidance elements are formed at least in part in a material having relative permeability of more than 10 000 and preferably more than 100 000.

This type of guidance element can be saturated using a low energy electromagnetic wave. The possible use of low excitation energy to obtain a reliable response increases the portability of the guidance system comprising the excitation means and the detection means.

Additionally, the parasitic magnetic elements present in the ground, which are reduced in number compared with the conducting elements, are difficult to saturate.

Therefore is a low energy wave is transmitted, only the guidance elements will emit a response in the form of identifiable waves.

Preferably, the excited guidance elements are formed, at least in part, of nanocrystalline material.

Other types of magnetic elements with high relative permeability can be used, preferably when used in the form of a strip of thickness about 30 microns.

Nanocrystalline alloys are alloys with a composition of type (Fe_{74.5}Si_{13.5}B9Nb₃,Cuₓ), manufactured by rapid annealing on a wheel rotating at high speed, or alloys of FeZrBCu type, or any type of alloy with like properties.

According to one characteristic of the invention, the excitation means and detection means are arranged on the vehicle, at a distance of more than 20 cm from the guidance element, preferably more than 40 cm, even more than 60 cm, and further preferably more than 80 cm even more than 1 m.

Having regard to the read reliability, it is possible to increase the distance between the detection system comprising the excitation means and detection means, and the support provided with the guidance element. With said distance, it is possible to prevent deterioration of the detection system in the event of obstacles or unevenness of the support surface.

According to one possibility of the invention, the guidance elements are sized so as to generate a magnetic field with axial symmetry when they are excited.

Preferably a plurality of guidance elements is affixed to the support along a travel pathway of the vehicle.

According to one characteristic of the invention, the guidance elements are arranged so as to form a code representing an event, for example the presence of an obstacle, said code being detected during travel of the vehicle.

### BRIEF DESCRIPTION OF THE DRAWINGS

At all events, the invention will be properly understood with the help of the following description, with reference to the appended schematic drawings which illustrate several embodiments of this guidance method as non-limiting examples.

FIG. 1 is a schematic view of a vehicle equipped with a detection system, mobile on a road.

FIG. 2 is a schematic view showing the positioning of the coils or magnetometer sensors of the detection system.

FIG. 3 is a block diagram showing the structure of the transmitter means.

FIG. 4 is a block diagram showing the structure of the detection means.

FIGS. 5 to 7 illustrate a road equipped with a guidance element forming a code representing an event.

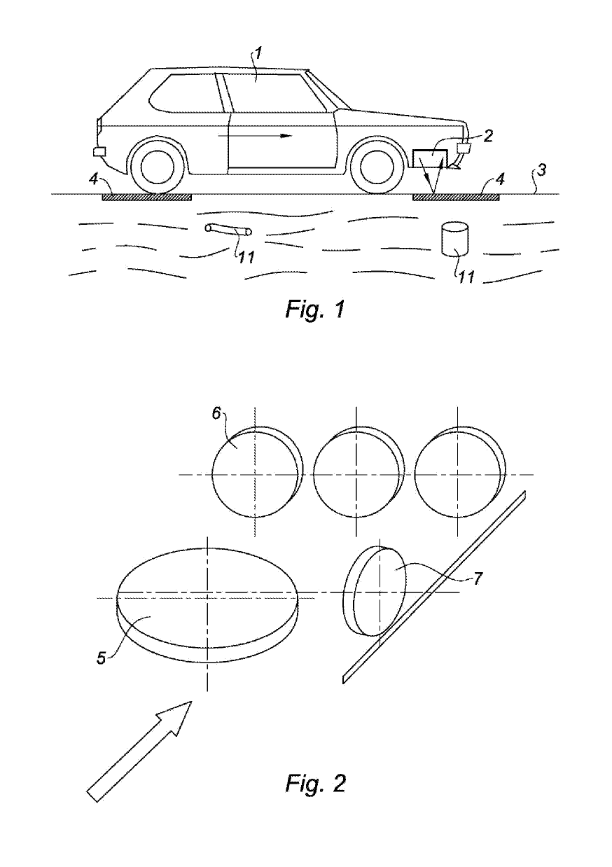

FIG. 1 shows a vehicle 1 equipped with a detection system 2, travelling on a road 3.

### DETAILED DESCRIPTION

Guidance elements 4 in the form of elongate labels are directly arranged under or on the surface of the road 3. The guidance elements 4 are spaced apart by a distance of at least one metre, and are made in nanocrystalline material. This type of material has high permeability, of more than 10 000. The guidance elements 4 are protected from corrosion, for example by coating between two polyethylene sheets, and are of narrow thickness of the order of 25 μm, with dimensions of the order of 500×30 mm. The ratio of the cross-section divided by length is chosen so that the demagnetising field of the material is sufficiently weak so that it does not oppose magnetisation of the strips.

It is also possible to use a guidance element in the form of a continuous strip.

The detection system 2 is embedded in the vehicle 1 and comprises means to excite the guidance elements 4, generating an electromagnetic wave whose intensity allows saturation or modification of the operating point of the guidance elements in their operating cycle, which then emit a frequency-rich signal comprising a wave of fundamental frequency and waves of frequencies that are multiples of the value of the fundamental frequency, called harmonics. More particularly, the electromagnetic wave alternately saturates the magnetic material and thereby generates harmonics.

The detection system 2 further comprises detection means, capable of detecting the signal emanating from the guidance elements, and signal processing means allowing the signal from the detection means to be collected and processed so as to guide the vehicle.

The structure of the detection system is schematically illustrated in FIG. 2.

As can be seen in this figure, the excitation means comprise a transmitter coil 5 through which an alternate current passes at a frequency f₀, which is the fundamental excitation frequency of the guidance elements 4. The excitation coil is placed on the vehicle 1, at a distance of the order of 1 metre from the surface of the road 3.

The dimensions of the guidance elements 4 are adjusted so as to limit the influence of the demagnetising field. The demagnetising field results from the geometric characteristics of each guidance element, and opposes the influence of an external excitation magnetic field.

In response to the excitation of the guidance elements 4 by the transmitter coil 5, each guidance element behaves as an antenna which transmits electromagnetic waves comprising the fundamental frequency f₀ and of the harmonic frequencies 2 f₀, 3 f₀, n f₀.

The transmission frequency f₀, according to one possibility of the invention, lies between 5 and 50 kHz, preferably of the order of 10 kHz.

To reduce transmission power without reducing the level of the transmission current allowing saturation, the excitation signal is transmitted in the form of pulses comprising a notched sinusoid of frequency f₀. The number of periods of the sinusoid is typically of the order of 200 periods per notch half-period. The number of periods and transmission power can be adjusted.

The notches include square signals varying between the two levels 0 and 1 and with a period that is a multiple of the period of the sinusoid signal of frequency f₀. The duration of level 1 is used to adjust transmission power.

The transmitter coil 1 can be replaced by a radar fixed to the vehicle, or by an antenna.

The detection means further comprise receiver coils 6, 7.

The receiver coils 6, 7 are positioned in zones called <<shadow zones>> and are tuned to the multiple frequencies of the excitation frequency f₀ (harmonics) so as to detect the magnetic field emitted by each guidance element.

A shadow zone is defined as a zone in which the total flow of the magnetic field generated by the transmitter coil in the receiver coil is very low, even zero in the absence of a target.

With respect to the receiver coils, it is ascertained that the coils are preferably sensitive to the field emitted by the guidance elements or strips 4 lying orthogonal thereto, and are little sensitive to the fields emitted by the strips lying parallel to the plane of the receiver coil 6,7.

The presence of harmonics in the signal emitted by the strips is due to the non-linear nature of the field set up by the magnetic material used. The frequencies used by the detector, in the case described below, are the second (2 f₀) and third (3 f₀) harmonics of the excitation signal. Evidently, other harmonics may be used.

In addition to the non-linear characteristic of the magnetic guidance elements 4, the detection system 2 also makes use of the geometry of the magnetic material used, which translates as a preferred longitudinal direction of magnetisation. This characteristic, in addition to the position of the guidance element 4, allows use of the orientation thereof in relation to the direction of movement of the receiver coils 6,7.

On this account, a distinction is made between two types of receiver coils.

The first type is composed of coil(s) 7 whose faces lie parallel to the direction of travel of the vehicle 1 indicated by the arrow. The coils of this type are sensitive to the guidance elements 4 arranged perpendicular to the direction of travel. These coils 7 are called <<transverse coils>>.

The second type is composed of coil(s) 6 whose faces lie orthogonal to the direction of travel of the vehicle. Unlike the transverse coils 7, these coils 6 are rather more sensitive to the elements 4 arranged in the direction of travel of the vehicle 1. These coils 6 are called <<longitudinal coils>>.

More particularly, the detection means may comprise several longitudinal coils 6 arranged side by side, whose use firstly allows identification and tracking of the guidance elements 4 arranged in the form of a circuit to be followed or breadcumb circuit, and secondly an improvement in the reliability of the detector when confronted by possible perturbing elements present on the ground.

As previously, the receiver coils 6, 7 are arranged at a distance of the order of 1 m from the surface of the road 3.

According to another possibility of the invention, the receiver coils can be replaced by magnetometers.

The signals emanating from the different coils 6, 7 are processed using processing means.

These means are associated with means for measuring the travel of the vehicle 1, allowing measurement of the speed and/or distance travelled. The vehicles are conventionally equipped with said means so that it is possible to retrieve such data for processing thereof in order to guide the vehicle, without requiring the use of additional means.

The means for processing the signal emanating from the receiver coils 6,7 comprise a high-pass filter allowing rejection of the fundamental frequency _{f0}

Rejection of the fundamental frequency f₀ allows a reduction in the perturbation, induced by the transmitter coil 5, on measurement of the signal emitted by the guidance elements 4 towards the receiver coils 6, 7;

Said filtering also allows makes it possible to discriminate between the signals emanating from the guidance elements 4 and those emanating from conducting parasitic elements 11 buried in the ground, in the vicinity of the guidance elements 4.

At the output from the above filter, the signals corresponding to the harmonics are amplified before being processed.

In this case, two methods for processing the signal can be used, namely a first method which samples the signals emanating from the guidance elements 4 and received by the receiver coils 6, 7, and a second method comparing the analogue signals received by the receiver coils 6, 7.

With the first method, namely sampling of the signals emitted by the guidance elements, the signals derived from the amplification step are acquired via an acquisition card, and then sampled at a high frequency to ensure good representation of the acquired signals.

The signals derived from each of the receiver 6, 7 and/or transmitter 5 coils are synchronized.

The signals derived from the receiver coils 6, 7 are then compared and the differences evaluated.

When the signals received by the longitudinal receiver coils 6 arranged symmetrically relative to the guidance elements 4 are equal, it can be inferred that the vehicle 1 is centred on the guidance elements.

If the difference between the signals of the longitudinal receiver coils 6 is negative, or positive, this means that the vehicle 1 is deviating from the assigned direction. Those skilled in the art then know how to process the data and to correct the change in direction of the vehicle.

With the second method, namely analogue processing of signals, the signals derived from each coil 6, 7 which were processed by filtering are analogue signals. It is then possible to compare the analogue signals directly, without prior processing by sampling.

In this way, it is possible to compare the mean flow emanating from the guidance elements 4 in the coils lying orthogonal thereto, and to infer the position of the vehicle 1 in relation to said guidance elements 4. In particular, when the magnetic flows are equal, this means that the coils 6 are arranged symmetrically relative to the guidance elements 4, and that as a result the vehicle 1 is correctly positioned.

The energy source used for functioning of the detection system is the battery of the vehicle, capable of delivering a current of approximately 50 Ah. The power of said battery is sufficient to saturate the magnetic guidance elements 4.

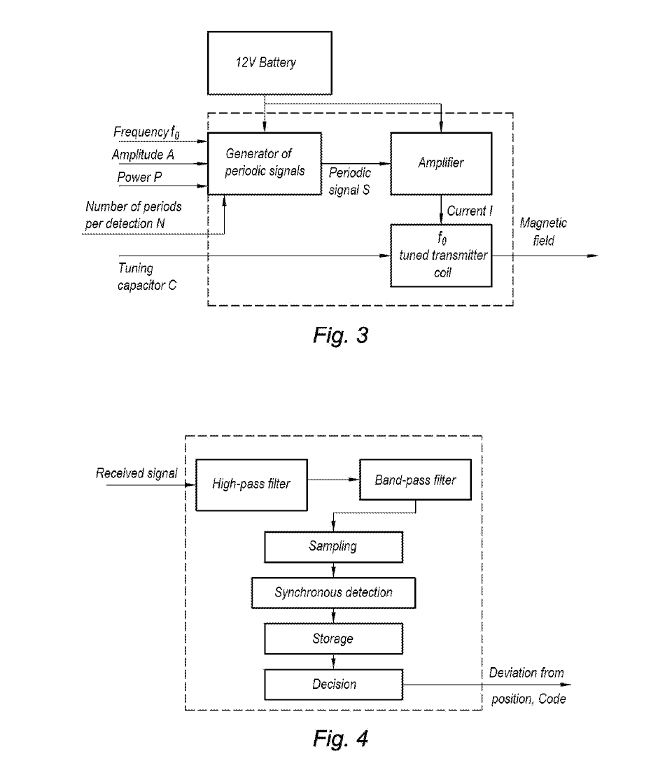

The functional layout of the transmitting means is illustrated FIG. 3.

As can be seen in this figure, the battery powers a generator of periodic signals and an amplifier. At the input to the generator of periodic signals, the operator can choose the frequency, amplitude and power of the signal transmitted by the corresponding coil 5. At the output of said generator, the created periodical signal is sent to the amplifier that will generate a current I which, on passing through the transmitter coil 5 tuned to frequency f₀, generates a sufficient magnetic field to excite the guidance elements 4.

In the case presented, the transmission signal S is defined by the following function:

S(t)=A sin(2πf₀t)·P(t)

P(t) is a square signal with values 0 and 1 expressing the power transmitted during the N periods by detection of the excitation signal.

The illustration relates to the case of a vehicle travelling at slow speed, for example about 20 km/h. For faster travel speeds, the signal is to be transmitted at high frequencies compatible with the properties of the magnetic alloys used. In this case, the signals are transmitted by a radar.

A tuning capacitor C is arranged in series with the transmitter coil 5, its value being a function of the transmission frequency f₀. Value C is defined in the following manner:

$$C = \frac{1}{{L ( 2 π {f}_{0} )}^{2}}$$

L being the inductance of the transmission coil.

In the embodiment described here as an example, the excitation current has an intensity of 10 A so as to generate a magnetic field that is sufficient to saturate the magnetic guidance elements 4.

The value of this field is 7.2 A/m at a distance of 1 m from the transmitter coil.

The characteristics of the transmitter coil are the following:
Diameter of the copper wire: 0.8 mm;
Diameter of the coil: 400 mm;
Number of turns: 90;
Inductance: 7.7 mH;
Resistance: 3.9 Ω

The functional layout of the signal receiver and processing means is illustrated FIG. 4.

As indicated in this figure, the processing of the signal received by the receiver coils 6, 7 comprises the following steps:
Filtering the fundamental frequency;
Amplification;
Sampling;
Synchronous detection of harmonic frequencies 2 f₀ and 3 f₀;
Data storage;
Comparison with a data bank;
Decision

The receiver coils 6, 7 are similar and have the following characteristics:
Diameter of the copper wire: 0.315 mm;
Diameter of the coil: 200 mm;
Number of turns: 75;
Inductance: 2.46 mH;
Resistance: 10.6 Ω.

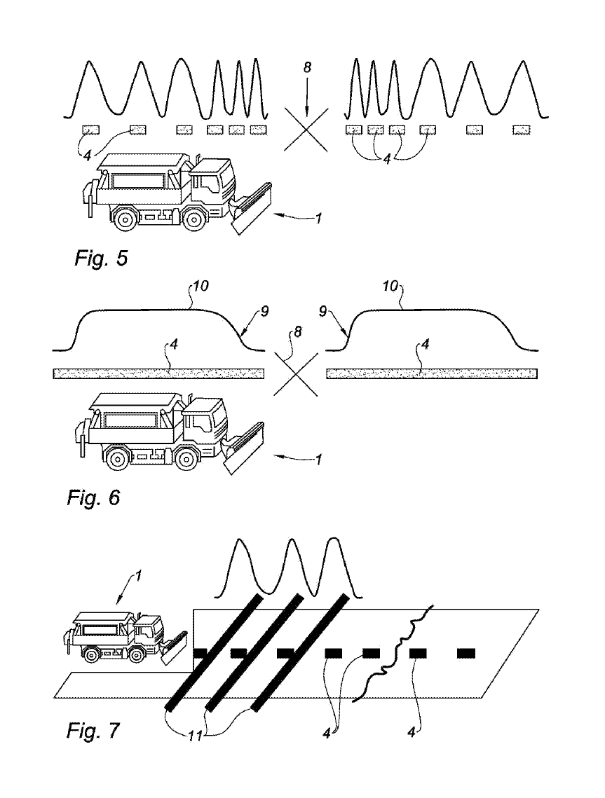

As illustrated FIGS. 5 to 7 the detection system 2, in addition to the guiding of a vehicle 1, can also be used for the detection of events such as an obstacle, an intersection, speed limit, traffic lights or road sign.

If there are a plurality of guidance elements 4 separated from each other and arranged along the travel pathway, it is possible to cause the spacing between said elements to vary when approaching the event 8 to be detected, said arrangement then being detectable by means of the detection system 2.

If the guidance element is in the form of a continuous line, it is possible to make a break said line on approaching the event 8. This results in a sudden variation 9 in the detected signal 10, said variation easily being identifiable.

It is also possible to arrange one or more strips 11 in magnetic material crosswise relative to the direction of travel of the vehicle 1. In this case, all that is necessary is to equip the vehicle with sensors capable of detecting a magnetic field perpendicular to the direction of travel of the vehicle.

Evidently, the invention is not limited to the sole embodiments of this guiding method described in the foregoing as examples, but on the contrary it encompasses all variants.

It concerns vehicles in the broadest sense, but more particularly finds application in the guiding of land motor vehicles such as snow ploughs for example, or in the guiding of aircraft during taxiing phases on the runway before takeoff and after landing.

1. Method of guiding a vehicle comprising:
during travel of the vehicle, exciting at least one guidance element in high-permeability magnetic material affixed to a support via excitation means,
detecting a signal emanating from the guidance element subsequent to excitation, via detection means,
collecting and processing a signal emanating from the detection means to guide the vehicle,
wherein the excitation of the guidance element is performed so as to saturate or modify an operating point of the guidance element during an operating cycle, which then emits a frequency-rich signal comprising a wave of fundamental frequency and of waves of frequencies that are multiples of the value of the fundamental frequency and wherein excitation is produced via a plurality of coils or by a radar generating a rotating excitation magnetic field.

2. The guiding method according to claim 1, wherein the guidance element is excited via at least one transmitter coil.

3. The guiding method according to claim 1, wherein the signal emanating from the guidance element is detected via at least one receiver coil tuned to the frequency of one or more harmonics emanated from the guidance element.

4. The guiding method according to claim 1, wherein the excited guidance elements are formed, at least in part, in a material having a relative permeability of more than 10 000.

5. The guiding method according to claim 4, wherein the excited guidance elements are formed, at least in part, in nanocrystalline material.

6. The guiding method according to claim 1, wherein the excitation means and the detection means are arranged on the vehicle at a distance of more than 20 cm from the guidance element.

7. The method according to claim 1, wherein the guidance elements are sized so that, when excited, they generate a magnetic field of axial symmetry.

8. The method according to claim 1, wherein a plurality of guidance elements is affixed to the support, along a pathway to be followed by the vehicle.

9. The method according to claim 8, wherein the guidance elements are arranged so as to form a code representing an event, comprising the presence of an obstacle, said code being detected as the vehicle is travelling.
